(19) United States
(12) Patent Application Publication
(10) Pub. No.: US 2010/0098933 A1
(43) Pub. Date: Apr. 22, 2010

(54) LIGHTWEIGHT WOOD-BASED BOARD AND PROCESS FOR PRODUCING IT

(75) Inventors: Jan Lüdtke, Hamburg (DE); Johannes Welling, Reinbek (DE); Heiko Thömen, Reinbek (DE); Marius Câtâlin Barbu, Brasov (RO)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: UNIVERSITAT HAMBURG, HAMBURG (DE)

(21) Appl. No.: 12/518,419

(22) PCT Filed: Dec. 6, 2007
(86) PCT No.: PCT/EP07/63424

§ 371 Date: Dec. 10, 2009

(30) Foreign Application Priority Data
Dec. 11, 2006 (DE) 20 2006 018 792.8
Mar. 13, 2007 (DE) 10 2007 012 597.8

(51) Int. Cl. B32B 5/14; B32B 3/02; B32B 37/24

(52) U.S. Cl. 428/310.5; 156/79; 156/78; 156/538

(57) ABSTRACT

The invention relates to a method for producing a sandwich panel, comprising the steps: providing an upper cover layer, providing a lower cover layer, providing an intermediate layer disposed between the upper and lower cover layers, compacting the upper and lower cover layers; foaming the intermediate layer, with no foaming of the intermediate layer occurring when compacting of the upper and lower cover layers begins.

The invention relates to a method for producing a sandwich panel, comprising the steps:
a. providing an upper cover layer,
b. providing a lower cover layer,
c. supplying an intermediate layer disposed between the upper and lower cover layers,
d. compacting the upper and lower cover layers,
e. foaming the intermediate layer,

The invention also relates to an engineered wood panel of sandwich construction, comprising:
a. at least one upper cover layer,
b. at least one lower cover layer,
c. at least one foamed intermediate layer disposed between the upper and lower cover layer, which has a lower density than the upper and lower cover layer and joins said layers.

Engineered wood panels of lightweight construction, of the kind initially specified, play an increasingly important role in manufacturing industry. The advantages of such lightweight engineered wood panels are savings in the materials required per unit of area, with subsequent cost savings, and the possibility of producing these lightweight engineered wood panels using cost-efficient production methods, on the one hand, and their favourable strength-to-weight ratio, on the other hand.

Lightweight engineered wood panels are typically made in mass production processes. A crucial aspect thereby is the high quality of panel production, on the one hand, and cost-efficient panel production, on the other hand. A basic distinction is made in the production processes used today between single-step and multi-step processes. In multi-step processes, actual production of the lightweight engineered wood panels is preceded by the production of layers, or at least of some of these layers. In this way, a lightweight engineered wood panel can typically be produced in such a way that at least two high-density engineered wood layers are prefabricated in an upstream production stage, and that these prefabricated panel parts are subsequently supplied, for example as thin chipboards or medium density fibreboard (MDF) panels, to a downstream production stage, where said two cover panels are joined to a low-density middle layer disposed between them to form the lightweight engineered wood panel. The low-density middle layer can be manufactured simultaneously during the final production stage, or can likewise be supplied as a prefabricated panel material to the final production stage.

The prefabricated layers are usually provided in the form of semi-finished panels with specific surface dimensions. These panels are then processed in a further, discontinuous production step to form the lightweight panels. When the mechanical requirements are lower, the high-density layers can also be prefabricated so that they are supplied as film or paper material in a semi-endless operation, for example from a wound state, in order thus to achieve continuous production using prefabricated cover or intermediate layers.

One disadvantage of this multi-step way of producing using prefabricated layers—whether continuous or discontinuous—is the fact that a production process with at least two steps is always required, which increases the total manufacturing cost.

In order to avoid this disadvantage, it is known from DE 10 2004 006 385 A1 to produce all the layers required for making the lightweight engineered wood panels simultaneously in a single production process and to join the layers together to form a lightweight engineered wood panel. In said method, a cover layer, an intermediate layer and another cover layer are successively sprinkled in particulate form, wherein a particle mixture of such a type is sprinkled in the middle layer that the layer can be foamed by thermal activation. The three sprinkled layers are then fed between two boundary panels, and thermal activation of the middle layer is started. This causes the middle layer to foam and generates a pressing force which presses the two cover layers against the boundary panels, thus compacting them and leading to formation of the lightweight engineered wood panel.

Although such a method provides the basic advantage that prefabrication of panel layers is no longer required, one disadvantage that arises is that the cover layers can be compressed by the foam pressure to a certain density only. Furthermore, the foam density cannot be reduced below a certain level due to the interior pressure in the foam. However, the load capacity and functionality of lightweight engineered wood panels is highly dependent on compacting their cover layers as much as possible and on minimising the density of the intermediate layer, so the continuous, single-step manufacturing process according to DE 10 2004 006 385 A1 also involves a reduction in the quality of the finished product.

It has been found that the foamable material required for the invention is often difficult to handle in terms of process engineering, be it because it can only be dosed using complex measures, or because special safety measures must be taken due to hazards to health and due to the formation of dust.

The object of the invention is to provide a method that allows cost-efficient production of engineered wood panels of lightweight construction, on the one hand, while also allowing better quality to be achieved than with known cost-efficient methods. Another aim of the invention is to provide an engineered wood panel of lightweight construction that can be manufactured cost-efficiently and is of higher quality than known, cost-efficient engineered wood panels of lightweight construction.

The object is achieved, according to a first aspect of the invention, by a method of the kind initially specified, in which no foaming of the intermediate layer occurs when compacting of the upper and lower cover layers begins.

The invention will now be described with reference to a three-layer lightweight engineered wood panel comprising two cover layers and a foamed intermediate layer disposed between said cover layers. However, it must be understood that lightweight engineered wood panels can be formed with a different number of layers using the principle of the method of the invention and the device of the invention. For example, five-layer lightweight engineered wood panels can be embodied in which the intermediate layer of the three-layer panel structure is divided into two foamed intermediate layers by a highly compacted middle layer, and panel structures with seven, nine or more layer can be realised in the same manner. Lightweight engineered wood panels comprising only one cover layer and one foamed layer can also be realised in the same way with the method of the invention and the device of the invention, for example by subsequently splitting a three-layer structure horizontally through its intermediate layer. In the nomenclature of this patent application and the claims, the expression “intermediate layer” is used for any foamed layer, and the expression “cover layer” is used accordingly for any highly compacted layer, even when the intermediate layer does not in fact lie geometrically between two layers, or the cover layer does not in fact lie geometrically as an outer layer.

The method of the invention allows all the layers of the multilayer panel to be provided in the respective layering in a one-step method, and for them to be joined together to form the engineered wood panel. This allows the lightweight engineered wood panel to be manufactured in a cost-efficient production process, and hence the resultant economic advantages to be achieved. Unlike the known method, however, in the production process according to the invention the pressing force required for compacting the cover layers and, where relevant, any high-density intermediate layer is not generated substantially by foam pressure of the foaming light intermediate layer(s). Instead, according to the method of the invention, the compacting of the cover layers and, where relevant, of any high-density intermediate layers to be produced, is carried out by compressing them with a pressing force applied externally to the layers. No foaming of the intermediate layer occurs, at least when compaction of the upper and lower cover layers begins, i.e. the production process according to the invention does not require any foam pressure when the compaction operation starts, but the pressing force is achieved instead by an advancing movement of at least one pressing plate disposed above and below the layers to be compacted, or by a feeding movement of the layers to be compacted into a narrowing gap between such pressing plates.

The method of the invention thus allows the highly compacted layer of the lightweight engineered wood panel to be compacted with a substantially higher pressing force than is possible with known methods in which the pressing force of the foam pressure is used. The layers between the layers to be pressed until they are highly compacted can be used thereby as separating layers in order to prevent joining of the cover layers to be highly compacted and, where relevant, of the intermediate layers.

The inventors have discovered that, with the method of the invention, a higher density can be achieved in the layers to be highly compacted than can be achieved with the single-step production methods known hitherto. Lightweight engineered wood panels produced with the method of the invention are distinguished, for example, by their comprising highly compacted cover layers and, where relevant, highly compacted intermediate layers that have a density greater than 500 kg/m³ (absolutely dry) and in particular with densities greater than 650 kg/m³ (absolutely dry). Furthermore, the method of the invention allows lightweight panels to be produced whose high-density layers have a density that is 5/3 or more of the density of the low-density layers. Until now, such highly compacted layers and densities for the production of engineered wood panels of sandwich construction with a foamed intermediate layer could only be achieved in two-step or multi-step production processes. However, engineered wood panels made in such two-step or multi-step processes are typically distinguished by the boundary between high-density and low-density layers running as a sharp and planar separating line. In contrast, it is possible with the method of the invention to produce an engineered wood panel in which the boundary surface between high-density cover layers and the intermediate layers to be subjected to a low level of compaction runs unevenly, in particular with a waviness that is greater than that of the outer surfaces of the cover layers, as a result of which favourable mechanical interlocking in the boundary surfaces is achieved. As a result of these effects, the lightweight engineered wood panels produced with the method of the invention also have decisive advantages with regard to their mechanical load capacity, in addition to the cost benefits, compared to the lightweight engineered wood panels produced with the production processes known hitherto. These advantages that cannot be achieved either by engineered wood panels made in single-step production processes or by panels made in two-step or multi-step production processes.

According to another aspect of the invention, the problem addressed by the invention is solved by a method of the kind initially specified, in which the upper and lower layers are compacted before the intermediate layer is foamed. In this aspect of the invention, the entire compaction of the upper and lower cover layers and, where relevant, of the additional intermediate layer to be highly compacted, occurs before the intermediate layer to be subjected to a low level of compaction is foamed. The method can be carried out in such a way, in particular, that the layers are firstly supplied to a mechanical press and continuously or discontinuously compacted by externally applying a pressing force onto the layers, wherein the intermediate layers to be foamed later on can act as a separating layer, and foaming of the intermediate layers occurs after this compacting. The pressing force can be generated, in turn, by providing at least one pressing plate in the direction of thickness, or by feeding into a narrowing gap between two pressing plates.

According to a first preferred embodiment, the foaming process includes an expansion operation. By this means, the low density of the light intermediate layers can be achieved in an especially efficient manner. The foaming process can be carried out by thermally activating an aerating agent, in particular, with subsequent physical (phase transition) or chemical reaction of the aerating agent, or, instead, by means of a delayed reaction of two or more components after they are mixed together when providing the intermediate layer.

In particular, it is preferred that the upper and lower cover layers are provided by sprinkling a particulate starting material, and are compacted by applying a pressing force between two pressing plates disposed above and below the sprinkled material. With this development of the invention, two independent developments of the method are provided. On the one hand, the individual cover layers are provided in an efficient and, for multiple layer materials, useful manner. Furthermore, and independently of the manner in which the cover layers are provided, a high pressing force is efficaciously achieved with this embodiment, in that the pressing plates are either impinged externally with an appropriate pressing force and moved towards each other as a result, or the position of the pressing plates is fixed during the pressing operation by means of an appropriate pressing or retaining force, and the layers to be compacted are fed between the pressing plates and compacted by means of a tapering wedge-shaped gap profile between the pressing plates.

The particulate coating is currently a widespread technology for producing lightweight engineered wood panels. However, the method of the invention is also suitable, in principle, for other types of coating, for example liquid types of coating in which a liquid material is applied as a film, in the form of droplets or in a form that is pre-partitioned in some other manner, for example in the form of regularly or irregularly arranged filaments.

It is also preferred that the intermediate layer consists of a material which can be foamed by thermal activation and which is foamed by thermal activation. By means of thermal activation, foaming of the intermediate layer can be controlled and/or started well within the process itself. In particular, it is possible for the start of the foaming process to be delayed by a certain period, for example by delaying the conducting of heat and by delaying the physical foaming operation by phase conversion of a solid or liquid material into the gaseous phase, or with a delayed chemical process that is activated by the application of heat.

It is particularly preferred when the heat required for thermal activation of the intermediate layer is supplied during compression of the upper and lower cover layers. In this way, a delay in the foaming operation after thermal activation can be advantageously used to begin or to complete pressing prior to the foaming operation.

It is particularly preferred in this regard that the heat is introduced by means of heated pressing plates. As a result of the close contact between the pressing plates and the coated material, heat can be introduced into the material in a particularly efficient manner via the pressing plates. The heat can be introduced during the pressing operation, on the one hand, and can lead to foaming by delaying the foaming operation accordingly after the compaction process has started or finished, or heating and hence the introduction of temperature via the pressing plate can be carried out only after the compaction operation has been completed, with the pressing plates exerting no force or almost no force.

It is also preferred that the upper and lower cover layers are compacted by arranging them between two pressing plates, and that the distance of the two pressing plates from one another is reduced as the process advances. In this way, the distance between the two pressing plates can be reduced, on the one hand, by having the pressing plates lie parallel to each other and moved towards each other, as a result of which discontinuous pressing is achieved.

On the other hand, it is preferred, especially in order to achieve a continuous pressing operation, that the upper and lower cover layers are introduced between two fixed pressing plates, and that the distance of the two pressing plates from one another decreases by decreasing the distance between the two pressing plates in the feed direction of the upper and lower cover layers. The pressing plates are aligned here in such a way that they form a wedge-shaped gap between them, into which the material to be pressed in conveyed, and moved by the conveying operation into the region of narrowing gap between the pressing plates, whereupon continuous pressing between stationary pressing plates is achieved.

According to another, particularly preferred embodiment of the invention, the upper and lower cover layers are formed by applying a layer of particulate starting material and subsequently splitting this layer, and the intermediate layer is formed by introducing particulate starting material into the gap produced by said splitting. Hence, in this configuration of the method of the invention, no distinction is made as yet, during the application operation itself, between the upper and lower cover layers and, where relevant, any intermediate layer to be highly compacted, but these two or several layers to be highly compacted are provided as a contiguous, sprinkled layer. The layer sprinkled in this manner can be split once or several times along a plane lying parallel to the plane of the layers, and a different material which later forms the low-compaction intermediate layers of the lightweight engineered wood panels can be introduced into the gap or gaps thus produced.

In one variant of this development, the method of the invention can be further developed such that the upper and lower intermediate layers are formed by applying a particulate starting material to a substrate, and material applied to the substrate is moved between two pressing plates, compressed between them and subsequently separated. Hence, in this procedure, the layers to be highly compacted are not only provided as a contiguous common layer, but are also jointly compressed, as a result of which a single highly compacted layer is firstly produced in an intermediate stage of the production process, that is to be split later on along a plane running in the longitudinal direction of the layer, in order to introduce the intermediate layer to be subjected to a low level of compaction.

in particular, this introduction of the intermediate layer to be subjected to a low level of compaction can be achieved by splitting the layer into the upper and lower layers by means of a wedge or a horizontally extending bandsaw blade, in a constant relation to which the pressed layer is moved, and introducing the intermediate layer on the other side of this wedge or saw blade.

Introducing the intermediate layer can be carried out, in particular, by sprinkling, blowing or injecting the intermediate layer material, for example in particulate or in liquid form, as already described in the foregoing for the cover layer material.

It is also preferred when the intermediate layer is provided as a mixture of a substrate material and a foamable material. By means of a mixture of a substrate material and a foamable material, a particularly advantageous composition of the intermediate layer can be achieved that satisfies weight requirements, on the one hand, and requirements in respect of mechanical stability and ease of handling, on the other hand.

Another aspect of the invention involves a method of the kind initially specified, in which the intermediate layer is provided as a mixture of a substrate material and a foamable material.

With this aspect of the invention, disadvantages in respect of the handling of the intermediate layer material can be surmounted by introducing a substrate material in the form of a mixture as the intermediate layer material, in addition to the foamable material. By this means, it is possible not only to improve the ease of handling of the intermediate layer material, but also to reduce what are often the problematic, health-damaging effects resulting from dust formation.

It is particularly preferred in this context that the substrate material be present in the form of particles to which the foamable material is fixed, or that are saturated with the foamable material. By means of this configuration of a bond between the components of the substrate material and of the foamable material, in particular, for example, by bonding the foamable material to the particles of the substrate material to form mixed particles, an especially favourable consistency for processing is achieved.

As an alternative, it may be preferable that the substrate material is present in the form of a nonwoven layer, to which and/or in which the foamable material is fixed or saturated with the foamable material. This development of the method allows the intermediate layer material to be provided in a form that differs from the particulate form and which can be integrated into the continuous production process of the inventive method, thereby providing an ease of handling that is favourable for process control and safety at work.

The problem addressed by the invention is also solved by an engineered wood panel of sandwich construction, comprising:
a. at least one upper cover layer,
b. at least one lower cover layer,
c—at least one foamed intermediate layer disposed between the upper and lower cover layer, which has a lower density than the upper and lower cover layer and joins said layers,
   in which the upper and lower cover layers are highly compacted.

According to another aspect, the invention provides an engineered wood panel of sandwich construction, comprising:
a. at least one upper cover layer,
b. at least one lower cover layer,
c—at least one foamed intermediate layer disposed between the upper and lower cover layer, which has a lower density than the upper and lower cover layer and joins said layers,
   in which a substrate material surrounded by a foamed material is contained in the intermediate layer. With this configuration, an intermediate layer in the engineered wood panel is obtained that is especially well adapted to the mechanical requirements, and which constitutes a composite material due to the mixture of foam material and substrate material.

According to a first preferred embodiment of the two aforementioned engineering wood panels, the cover layers are compacted with a pressing force which is greater than the pressure generated by foaming the intermediate layer. By virtue of the high compaction of the two cover layers achieved in this manner, the mechanical strength of the engineered wood panel can be significantly increased compared to known engineered wood panels made in single-step production processes.

It is also preferred when the cover layers have greater waviness on the side facing the intermediate layer than on the side facing away from the intermediate layer, in particular a waviness that is three times greater. By means of the greater waviness thus achieved, which can take the form of a corrugation, but in particular as an irregular plane between the cover layer and the intermediate layer, mechanical interlocking can be achieved between the cover and intermediate layers, on the one hand, and, on the other, a microscopically gradual transition can be provided which improves the load transmission between the cover layer and the intermediate layer. This embodiment must be understood in such a way, in particular, that the sides of the cover layers facing away from the intermediate layer constitute the external surfaces of the engineered wood panel, which typically have a smooth surface, and that the sides facing the intermediate layer constitute the transitional plane inside the engineered wood panel.

According to the invention, it is particularly preferred when the cover layers have a density greater than 500 kg/m³ (absolutely dry), in particular greater than 650 kg/m³ (absolutely dry). It has been found that a high strength of the entire engineered wood panel is achieved with these densities.

It is also preferred when the ratio of the density of the cover layer to that of the intermediate layer is greater than 5:3, preferably greater than 5:1.5. The ratio of the densities of the cover layer and the intermediate layer is significant, in particular, for the ratio between the load capacity of the engineered wood panel and its total weight. As a basic principle, it is desirable, within a wide range of ratios, to achieve as high a density as possible for the cover layers in relation to the density of the intermediate layer, in order to obtain high strength and a low weight for the engineered wood panel, on the whole.

The engineered wood panel according to the invention is preferably produced, in particular, by means of the one-step production process according to the invention, as described in the foregoing, and in this case can have an especially low foam density while simultaneously having an especially high cover layer density, due to the fact that no foam pressure is used to compact the cover layer.

According to another preferred embodiment, a microscopically gradual density transition is formed between the cover layer and the intermediate layer. Such a microscopically gradual transition can be achieved, for example, by sprinkling particulate material to provide the individual layers, when targeted mixing of the different particle mixtures for the individual layer is achieved in the transitional regions between the individual sprinkled layers, or when these transitional regions are configured as gradually changing layers of sprinkled material by targeted sprinkling of particle mixtures composed of the particles of the individual layers. By means of gradual density transitions, stress peaks, particularly shear stress peaks, can be reduced in the transitional region between the cover layer and the intermediate layer, and the shear force to be transmitted can be distributed over a bigger volume of material, as a result of which the stress level as a whole can be reduced and the mechanical load capacity of the engineered wood panel can hence be increased.

It is also preferred that the cover layers consist of highly compacted material, and that the intermediate layer consists of a material which is foamed under the effect of heat. This configuration enables a number of materials that are advantageous for the cover and intermediate layers to be used in the engineered wood panel of the invention.

Another aspect of the invention, finally, is a device according to claims 26 to 31. The claimed device is suitable, in particular, for producing a lightweight engineered wood panel in the manner described above. In particular, the method described in the foregoing can be used for this purpose.

With regard to the introducing devices specified in claim 26, it is essential to understand that these can be configured as sprinkling devices, insufflation devices, or the like, in order to introduce a solid, particulate, liquid or liquid hardening material in particulate form, filament form, or the like. In this context, “particulate form” means any configuration of the material which is produced after applying a layer structure provided with cavities, and which is therefore amenable to subsequent compaction. In respect of the cover layer material, it should be understood, in particular, that a layer structure of maximum possible density is already desirable when the material is applied, and hence that the structure of the introduced cover layer material should already have as high a density as possible.

With reference to the separation device claimed in claims 28 and 29, it should be understood, in particular, that this can be configured as a splitting wedge or as a horizontally extending saw blade.

A particularly preferred embodiment shall now be described with reference to the attached Figures, in which

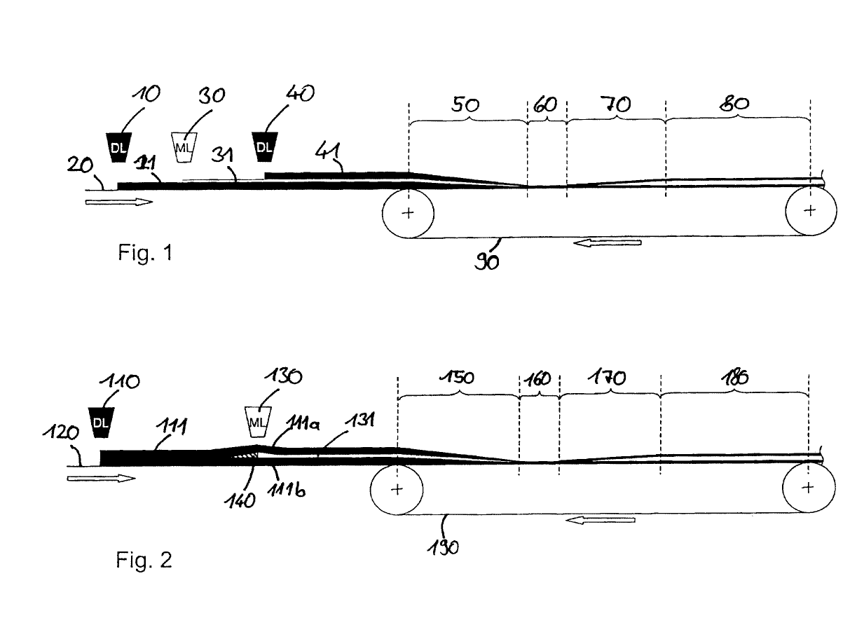

FIG. 1: shows a schematic view of the operational sequence of the inventive method, according to a first embodiment,

FIG. 2: shows a schematic view of the operational sequence of the inventive method, according to a second embodiment,

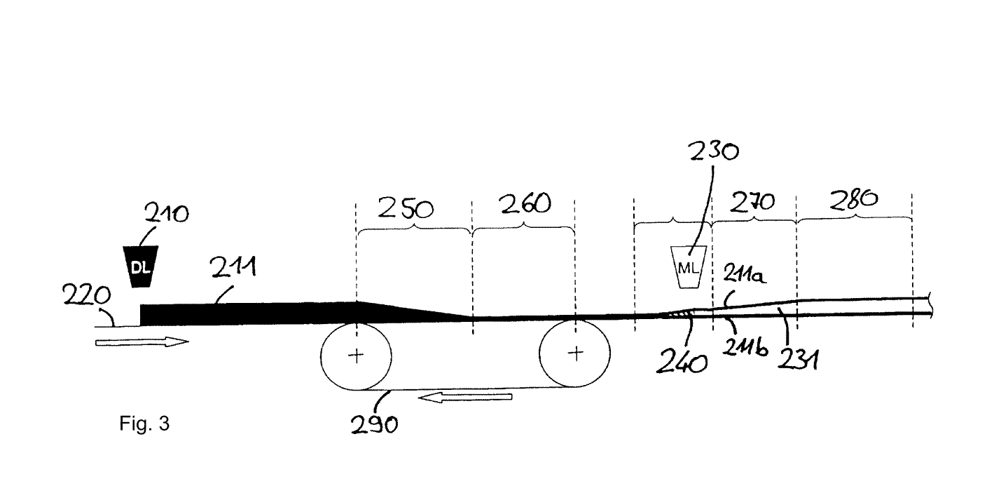

FIG. 3: shows a schematic view of the operational sequence of the inventive method, according to a third embodiment,

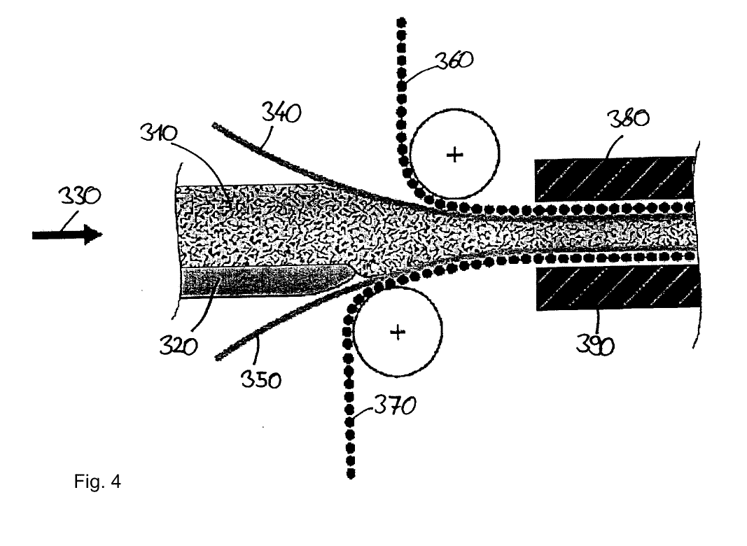

FIG. 4: shows a schematic view of a continuous press arrangement, and

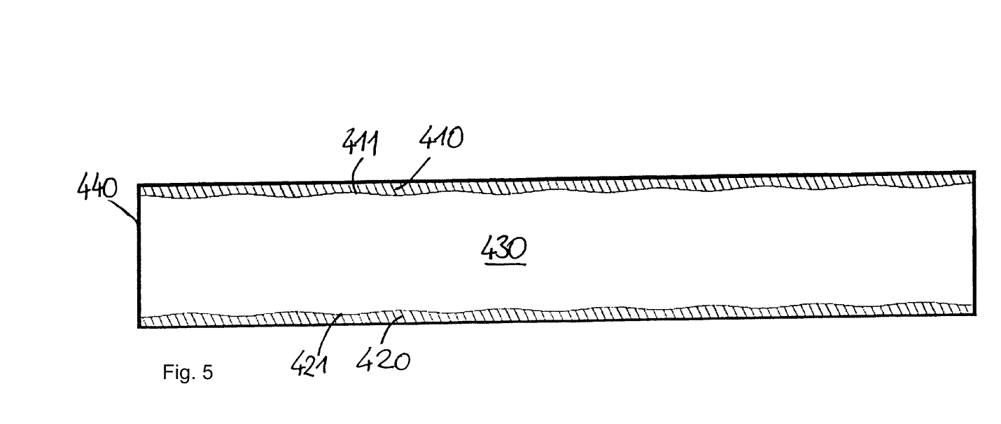

FIG. 5: shows a schematic cross-section through a lightweight panel produced with the method of the invention.

With reference firstly to FIG. 1, a cover layer material 11 is sprinkled, in a first embodiment of the method of the invention, onto a continuous substrate strip 20 by means of a sprinkling device 10.

In the conveying direction of substrate strip 20, downstream from the sprinkling device for the first cover layer 10, a sprinkling device 30 is disposed which sprinkles an intermediate layer material 31 onto the cover layer material 11 that has already been sprinkled onto substrate strip 10.

In the conveying direction of substrate strip 20, downstream from the sprinkling device 30 for the intermediate layer material 31, another sprinkling device 40 is disposed which sprinkles a cover layer material 41 onto the intermediate layer material 31 that has already been coated.

The composite of sprinkled layer thus produced, consisting of a lower cover layer 11, an intermediate layer 31 and an upper cover layer 41, is subsequently fed to a compacting station 50. In compacting station 50, the three sprinkled layers are compacted by moving them, by means of a conveyor belt 90, between one or several pairs of pressing plates arranged one behind the other, wherein the pairs of pressing plates leave a gap between them that narrows in the conveying direction of conveyor belt 90, such that the sprinkled layers are compacted in the direction of conveyance.

In this context, by “pairs of plates” is meant that the plates on the upper and lower sides can be arranged in pairs in relation to one another. However, such pairs can also be understood to mean other configurations, for example configurations in which two pressing plates arranged on one side are assigned to pressing plates arranged on the opposite side, or arrangements of plates in which the extension of upper and lower pressing plates intersect in an offset arrangement such that there is no direct assignment of an upper pressing plate to a corresponding lower pressing plate positioned directly opposite.

By means of such pressing, the density of sprinkled mats of fibres can be reduced in thickness to 2-5% of their original thickness. This reduction of thickness can be effected by pre-pressing, after which the thickness after pre-pressing is pressed to a final thickness that is 5-10% of the thickness achieved by pre-pressing. When pressing sprinkled fibre mats, a similar procedure involving pre-pressing and final pressing is frequently used, with a thickness of 20-50% of the thickness achieved after pre-pressing being achieved in the final pressing step.

The layering that is reduced in thickness in this manner is hardened and fixated, by the addition of heat, in a first hardening zone 60 between two pressing plates standing parallel to one another, which leave a gap of approximately constant thickness between them. On the one hand, the cover layers are hardened and fixated by means of this operation in the hardening zone. At the same time, a foaming operation triggered by thermal activation is started in the intermediate layer.

This foaming operation causes an expansion of the intermediate layer in an expansion zone 70 that follows in the conveying direction of conveyor belt 90, and a resultant increase in the thickness of the composite panel.

In a second hardening zone 80 that follows expansion zone 70 in the conveying direction of conveyor belt 90, the foamed composite of layers thus obtained is hardened by removing heat from the composite of layers and fixated in its shape by being conveyed between two parallel pressing plates that dissipate heat.

At the output of the second hardening zone 80, the three-layer lightweight panel material is further processed by means of conventional handling technology, in particular by cutting it to size.

FIG. 2 shows a second embodiment of the method according to the invention. In a sprinkling direction 110, a particulate cover layer material is sprinkled onto a substrate strip 120. This sprinkled layer 111 is conveyed by means of substrate strip 120 to a sprinkling device 130. Sprinkling device 130 acts in conjunction with a separation device 140, such as a splitting wedge or a horizontally extending saw band, which splits the sprinkled cover layer coating 111 in a horizontal plane parallel to the conveying direction of substrate strip 120, thus producing an upper sprinkled cover layer coating 111a and a lower, sprinkled cover layer coating 111b.

The intermediate layer material is introduced in particulate form, for example by injection or by blowing, into the gap produced by separation device 140 and in this way forms a sprinkled intermediate layer 131.

The three-layer composite of sprinkled layers produced in this manner is fed to a conveyor belt 190 for further processing, and is compacted, expanded and hardened as in the preceding embodiment according to FIG. 1 by means of a compacting device 150, a first hardening zone 160 that then follows, an expansion zone 170 and a second hardening zone 180, in essentially the same manner as a lightweight panel processed with conventional means.

FIG. 3 shows a third embodiment of the method according to the invention. As in the second embodiment described with reference to FIG. 2, a particulate cover layer material is firstly sprinkled onto a substrate strip 220 in this third embodiment also.

However, this sprinkled cover layer material 211 is not split horizontally, but is moved immediately by means of a conveyor belt 290 through a compression zone 250, where it is highly compacted and its thickness reduced accordingly. This highly compacted geometry of reduced thickness is fixated in a first hardening zone 260 that then follows in the conveying direction.

A second foaming device 230 is arranged downstream from the first hardening zone 260 in the conveying direction of the compacted composite of cover layers. Assigned to foaming device 230 is a separation device 240 which separates the compacted cover layer composite 211 into an upper and a lower cover layer 211a, b along a plane lying horizontal and parallel to the conveying direction. Into the slot-like cavity thus created between the two cover layers 111a, b, the intermediate layer material is introduced, for example by injecting or blowing, as a particulate intermediate layer material downstream from separation device 240. The composite of sprinkled and compacted upper and lower cover layers 211a, b produced in this manner, which are separated by the sprinkled intermediate layer material 231, is supplied to an expansion zone 270 that follows separation device 240 in the conveying direction of the cover layer composition, in which expansion zone the intermediate layer material is activated, and foamed as a result. In the embodiment described, this activation is carried out thermally by supplying heat, but can also be carried out in a different manner, for example by supplying a reactant, by irradiation or the like. The intermediate layer material expands in the process, and the entire layer composite is expanded as a result to a greater layer thickness.

In a subsequent second hardening zone 280, the thick layer thus obtained is hardened by heat dissipation between two stationary pressing plates arranged parallel to one another, and in this way a lightweight engineered wood panel that can be further processed using conventional means is obtained.

FIG. 4 shows in schematic form the arrangement of a continuous pressing device. In the configuration shown here, a particulate sprinkled coating material 310 is conveyed horizontally in a direction 330 on a substrate 320. The sprinkled coating material is bounded at the end of substrate 320 by an upper steel strip layer 340 and a lower steel strip layer 350. The upper steel strip layer 340 and the lower steel strip layer 350 are preferably embodied as endless steel strips.

The upper and lower steel strip layers 340, 350 are guided above and below by two endless belts of roller elements 360, 370 disposed on the sides opposite the sprinkled layer material that is trapped between said steel strip layers, and in this way are drawn in between two pressing plates 380, 390 in which they can be pressed.

As shown, compaction of the sprinkled material can already occur when the sprinkled material is trapped between the two steel strips 340, 350 and when subsequently guided along the roller element belts 360, 370, and the material can be highly compacted to the desired extent between the pressing plates, which, unlike in the embodiment described, can form a narrowing gap between them in the conveying direction.

Finally, FIG. 5 shows the schematic, not-to-scale cross-section of a lightweight panel produced with the method of the invention. An upper cover layer 410 and a lower cover layer 420 can be seen. The upper and lower cover layers 410, 420 trap an intermediate layer 430 between them, which is made of a foamed engineering wood material of low density. The boundary surface between the two cover layers 410, 420 and intermediate layer 430, shown by reference signs 411 and 421, is configured with an irregular corrugation, which is brought about by the production process according to the method of the invention.

1. A method for producing a sandwich panel, comprising the steps:
a. providing an upper cover layer (11),
b. providing a lower cover layer (41),
c. providing an intermediate layer (31) disposed between the upper and lower cover layers,
d. compacting the upper and lower cover layers,
e. foaming the intermediate layer,
characterised in that no foaming of the intermediate layer occurs when compacting of the upper and lower cover layers begins.

2. A method for producing a sandwich panel, comprising the steps:
a. providing an upper cover layer (11),
b. providing a lower cover layer (41),
c. providing an intermediate layer (31) disposed between the upper and lower cover layers,
d. compacting the upper and lower cover layers,
e. foaming the intermediate layer,
characterised in that the upper and lower cover layers are compacted before the intermediate layer is foamed.

3. A method according to claim 1, characterised in that the foaming process includes an expansion operation.

4. A method according to claim 1, characterised in that the upper and lower cover layers are provided by sprinkling a particulate starting material and are compacted by applying a pressing force between two pressing plates disposed above and below the sprinkled material.

5. A method according to claim 1, characterised in that the intermediate layer consists of a material which can be foamed by thermal activation and which is foamed by thermal activation.

6. A method according to claim 1, characterised in that the heat required for thermal activation of the intermediate layer is supplied during compression of the upper and lower cover layers.

7. A method according to the preceding claim,
characterised in that the heat is introduced by means of heated pressing plates.

8. A method according to claim 1, characterised in that the upper and lower cover layers are compacted by arranging them between two pressing plates, and the distance of the two pressing plates from one another is reduced as the process advances.

9. A method according to the preceding claim,
characterised in that the upper and lower cover layers are introduced between two fixed pressing plates, and the distance of the two pressing plates from one another decreases by decreasing the distance between the two pressing plates in the feed direction of the upper and lower cover layers.

10. A method according to claim 1, characterised in that the upper and lower cover layers are formed by sprinkling a layer of particulate starting material and subsequently splitting the one layer, and the intermediate layer is formed by introducing particulate starting material into the gap produced by said splitting.

11. A method according to claim 1, characterised in that the upper and lower intermediate layer is formed by sprinkling a particulate starting material onto a substrate and compressing the starting material, and the sprinkled material on the substrate is moved between two pressing plates, is compressed between them and subsequently separated.

12. A method according to claim 10,
characterised in that splitting the layer into the upper and lower cover layers and introducing the intermediate layer is carried out after compressing the upper and lower intermediate layer.

13. A method according to claim 1,
characterised in that the intermediate layer is provided as a mixture of a substrate material and a foamable material.

14. A method for producing a sandwich panel, comprising the steps:
a. providing an upper cover layer,
b. providing a lower cover layer,
c. supplying an intermediate layer disposed between the upper and lower cover layers,
d. compacting the upper and lower cover layers,
e. foaming the intermediate layer,
characterised in that the intermediate layer is provided as a mixture of a substrate material and a foamable material.

15. A method according to claim 14,
characterised in that the substrate material is present in the form of particles to which the foamable material is fixed.

16. A method according to claim 14,
characterised in that the substrate material is present in the form of a nonwoven layer, to which and/or in which the foamable material is fixed or embedded.

17. A engineered wood panel of sandwich construction, comprising:
a. at least one upper cover layer,
b. at least one lower cover layer,
c. at least one foamed intermediate layer disposed between the upper and lower cover layer, which has a lower density than the upper and lower cover layer and joins said layers,
characterised in that the upper and lower cover layers are highly compacted.

18. A engineered wood panel of sandwich construction, comprising:
a. at least one upper cover layer,
b. at least one lower cover layer,
c. at least one foamed intermediate layer disposed between the upper and lower cover layer, which has a lower density than the upper and lower cover layer and joins said layers,
characterised in that a substrate material surrounded by a foamed material is contained in the intermediate layer.

19. An engineered wood panel according to claim 17, characterised in that the cover layers are compacted with a pressing force which is greater than the pressure generated by foaming the intermediate layer.

20. An engineered wood panel according to claim 17,
characterised in that the cover layers have greater waviness on the side facing the intermediate layer than on the side facing away from the intermediate layer, in particular a waviness that is three times greater.

21. An engineered wood panel according to claim 17,
characterised in that the cover layers have a density greater than 500 kg/m³ (absolutely dry), in particular greater than 650 kg/m³ (absolutely dry).

22. An engineered wood panel according to claim 17,
characterised in that the ratio of the density of the cover layer to that of the intermediate layer is greater than 5:3, preferably greater than 5:1.5.

23. An engineered wood panel according to claim 17,
characterised in that a microscopically gradual density transition is formed between the cover layer and the intermediate layer.

24. An engineered wood panel according to claim 17
characterised in that the cover layers and/or the intermediate layer are comprised of sprinkled starting material.

25. An engineered wood panel according to the preceding claim,
characterised in that the cover layers consist of highly compacted material and the intermediate layer consists of a material that is foamed under the effect of heat.

26. A device for producing a lightweight sandwich panel, comprising
a conveying device having an upper support surface, which moves in a conveying direction,
a first introducing device for introducing a cover layer material, in particular a first sprinkling device for sprinkling a particulate cover layer material,
a second introducing device for introducing an intermediate layer material, in particular a second sprinkling device for sprinkling a particulate intermediate layer material,
a compacting device for compacting the cover layer material, and
a foaming device for foaming the intermediate layer material,
characterised in that the foaming device is disposed downstream from the compacting device in the conveying direction.

27. A device according to claim 26,
characterised in that the first introducing device comprises a first sprinkling device which sprinkles a cover layer coating onto the support surface of the conveying device and is disposed upstream from the second introducing device in the conveying direction, and a second sprinkling device which is disposed downstream in the conveying direction from the second introducing device for the intermediate layer and which sprinkles a particulate cover layer material onto the sprinkled intermediate layer.

28. A device according to claim 26,
characterised in that the second introducing device comprises a separation device which is disposed in the conveying direction between the first sprinkling device and the compacting device and which is configured to separate the cover layer coating in a horizontal plane lying parallel to the conveying direction of the conveying device,
wherein the second introducing device is configured to introduce the intermediate layer material into the gap which is generated by the separation device between the parts of cover layer material produced by separation.

29. A device according to claim 26,
characterised in that the second introducing device comprises a separation device which is disposed in the conveying direction between the joining device and the foaming device and separates the compressed cover layer coating in a horizontal plane lying parallel to the conveying direction, wherein the second introducing device is configured to introduce the intermediate layer material into the gap which is formed by separation between the two parts of the cover layer coating.

30. A device according to claim 26,
characterised in that a first hardening zone for hardening the compacted cover layer coating(s) is disposed between the compacting device and the foaming device.

31. A device according to claim 26,
characterised in that a second hardening zone for hardening the foamed intermediate layer is disposed downstream from the foaming device in the conveying direction.
